(19) United States
(12) Patent Application Publication
(10) Pub. No.: US 2014/0278965 A1
(43) Pub. Date: Sep. 18, 2014

(54) SYSTEMS AND METHODS FOR PROVIDING PAYMENT OPTIONS

(71) Applicants: Lawrence Douglas, McLean, VA (US); Paul Y. Moreton, Glen Allen, VA (US)

(72) Inventors: Lawrence Douglas, McLean, VA (US); Paul Y. Moreton, Glen Allen, VA (US)

(73) Assignee: CAPITAL ONE FINANCIAL CORPORATION, McLean, VA (US)

(21) Appl. No.: 14/212,926

(22) Filed: Mar. 14, 2014

Related U.S. Application Data
(60) Provisional application No. 61/789,264, filed on Mar. 15, 2013.

(51) Int. Cl. G06Q 20/22; G06Q 20/32

(52) U.S. Cl. CPC G06Q 20/227; G06Q 20/322
USPC 705/14.51; 705/39; 705/44

(57) ABSTRACT

The disclosed embodiments include methods, systems, and articles of manufacture for providing payment options. In one embodiment, a system may receive transaction information regarding a plurality of purchase transactions involving a plurality of merchants and customers of a financial service provider. The system may also determine a merchant and payment type for each of the plurality of purchase transactions based on the received transaction information. The system may further associate one or more of the determined payment types with each of the determined merchants. The system may also generate at least one configuration file reflecting the one or more of the determined payment types associated with each of the determined merchants. The system may also provide the at least one configuration file to at least one client device.

### CROSS-REFERENCE TO RELATED APPLICATIONS

This application claims priority under 35 U.S.C. §119 to U.S. Provisional Application No. 61/789,264, filed on Mar. 15, 2013, which is expressly incorporated herein by reference in its entirety.

### BACKGROUND

Customers today are provided with multiple ways in which to provide a payment for goods and/or services rendered by a merchant. For example, customers may complete the purchase of a product by swiping their credit card at a point-of-sale location, “bumping” their financial product against a payment terminal of the merchant employing near-field communication technology, employing third-party payment rails such as PayPal®, scanning a OR code, submitting a payment via merchant website, presenting an coupon, and so on. Some options for proving a payment are not yet widely available or incur a cost to those involved or incur a cost that may be higher than an alternative payment option available at the same point of sale. Thus, one or both parties involved in a transaction may prefer one method of payment to others.

Despite the many available methods to complete a purchase, customers and merchants today are left uninformed regarding the capabilities and preferences of the other for any particular transaction in terms of potential payment options. Thus, consumers and merchants may benefit from methods and systems that allow all parties to a transaction to account for the payment options available and insert their preferences into the decision of how to complete a transaction.

### SUMMARY

Disclosed embodiments include methods, systems, and articles of manufacture configured to provide payment options to customers using a mobile device. In one embodiment, a system may receive transaction information regarding a plurality of purchase transactions involving a plurality of merchants and customers of a financial service provider. The system may also determine a merchant and payment type for each of the plurality of purchase transactions based on the received transaction information. The system may further associate one or more of the determined payment types with each of the determined merchants. The system may also generate at least one configuration file reflecting the one or more of the determined payment types associated with each of the determined merchants. The system may also provide the at least one configuration file to at least one client device.

The disclosed embodiments may also include a method for providing payment options, including receiving transaction information regarding a plurality of purchase transactions involving a plurality of merchants and customers of a financial service provider. The method may also include determining, via one or more processors, a merchant and payment type for each of the plurality of purchase transactions based on the received transaction information. The method may also include associating one or more of the determined payment types with each of the determined merchants and generating, via the one or more processors, at least one configuration file reflecting the one or more of the determined payment types associated with each of the determined merchants. The method may also include providing the at least one configuration file to at least one client device

The disclosed embodiments may also include a tangible computer-readable medium having stored thereon executable instructions that, when executed by one or more processors, cause the one or more processors to perform operations, such as receiving transaction information regarding a plurality of purchase transactions involving a plurality of merchants and customers of a financial service provider. The operations may also include determining a merchant and payment type for each of the plurality of purchase transactions based on the received transaction information. The operations may further include associating one or more of the determined payment types with each of the determined merchants and generating at least one configuration file reflecting the one or more of the determined payment types associated with each the determined merchants. The operations may also include providing the at least one configuration file to at least one client device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2 is a block diagram of another exemplary system, consistent with disclosed embodiments.

FIG. 3 is a block diagram of another exemplary system, consistent with disclosed embodiments.

FIG. 4 is a block diagram of an exemplary client device, consistent with disclosed embodiments.

FIG. 5 is a flowchart of an exemplary payment option provider system configuration process, consistent with disclosed embodiments.

FIG. 6 is a flowchart of an exemplary mobile device configuration process, consistent with disclosed embodiments.

FIG. 7 is a flowchart of an exemplary customized suggestion process, consistent with disclosed embodiments.

FIG. 8 is an exemplary graphical user interface display sequences, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

FIG. 1 is a block diagram of an exemplary system 100 for performing one or more operations consistent with the disclosed embodiments. In one embodiment, system 100 may include one or more financial service provider systems 110, one or more payment processing systems 120, one or more payment option provider systems 130, one or more clients devices 150, one or more merchant systems 160, and network 140. The components and arrangement of the components included in system 100 may vary. Thus, system 100 may include other components that perform or assist in the performance of one or more processes consistent with the disclosed embodiments.

One or more of the components of system 100 may be one or more computing systems configured to provide a payment service consistent with disclosed embodiments. As further described herein, components of system 100 may include one or more computing devices (e.g., computer(s), server(s), etc.), memory storing data and/or software instructions (e.g., database(s), memory devices, etc.), and other known computing components. In some embodiments, the one or more computing devices are configured to execute software instructions stored on one or more memory devices to perform one or more operations consistent with the disclosed embodiments. Components of system 100 may be configured to communicate with one or more other components of system 100, including financial service provider system 110, payment processing system 120, payment option provider system 130, client devices 150, and/or merchant systems 160. In certain aspects, users may operate one or more components of system 100 to initiate one or more operations consistent with the disclosed embodiments. In some aspects, the one or more users may be employees of, or associated with, the entity corresponding to the respective component(s) (e.g., someone authorized to use the underlying computing systems or otherwise act on behalf of the entity). In other aspects, the user may not be an employee or otherwise associated with underlying entity. In still other aspects, the user may itself be the entity associated with the respective component (e.g., user 152 operating client devices 150).

Financial service provider system(s) 110 may be a system associated with an entity providing financial services. For example, financial service provider system 110 may be associated with a bank, credit card issuer, or other type of financial service entity that generates, provides, manages, and/or maintains financial service accounts for one or more users. Financial service accounts may include, for example, credit card accounts, loan accounts, checking accounts, savings accounts, reward or loyalty program accounts, and/or any other type of financial service account known to those skilled in the art. Financial service provider system 110 may include infrastructure and components that are configured to generate and/or provide financial service accounts such as credit card accounts, checking accounts, debit card accounts, loyalty or reward programs, lines of credit, and the like.

Payment processing system(s) 120 may be one or more computing systems configured to process payments between a payor and a payee, consistent with disclosed embodiments, as further described herein. In one embodiment, payment processing system 120 may be related to an entity that provides payment processing services. For example, payment processing system 120 may be a computing system provided by an automated clearing house (ACH). Payment option provider system 120 may include one or more computing devices (e.g., server(s)), memory storing data and/or software instructions (e.g., database(s), memory devices, etc.) and other known computing components. Payment option provider system 120 may be configured to communicate with one or more components of system 100, such as financial service provider system 110, payment option provider system(s) 130, merchant systems 160, and/or client devices 150.

Payment option provider system(s) 130 may be one or more computing systems configured to provide payment services consistent with disclosed embodiments, as further described herein. In one embodiment, payment option provider system 130 may be related to an entity that provides payment services or otherwise possesses access to information regarding the payment options available to merchants and/or users. For example, payment option provider 130 may be a computing system provided by a financial service provider or other business configured to facilitate payments and/or money transfers between parties. According to some embodiments, payment option provider 130 may be a computing system provided by a financial service provider 110. Payment option provider system 130 may include one or more computing devices (e.g., server(s)), memory storing data and/or software instructions (e.g., database(s), memory devices, etc.) and other known computing components. Payment option provider system 130 may be configured to communicate with one or more components of system 100, such as financial service provider system 110, payment processing system 120, merchant systems 160, and/or client devices 150. Payment option provider 130 may be configured to provide a payment service that provides interface(s) accessible by users over a network (e.g., the Internet) For example, according to some embodiments, payment option provider 130 may provide software executed on client devices 150 to perform one or more operations consistent with disclosed embodiments.

Client device(s) 150—exemplary depicted as client device 150A and client devices 150B-n—may be one or more computing devices configured to perform one or more operations consistent with disclosed embodiments. Client device 150 may be a desktop computer, a laptop, a server, a mobile device (e.g., tablet, smart phone, etc.), or any other type of computing device. According to some embodiments, client device 150 may comprise a network-enabled computing device operably connected to one or more other client devices.

Client device(s) 150 may include one or more processors configured to execute software instructions stored in memory, such as memory included in client device 150. Client device 150 may include software that when executed by a processor performs known Internet-related communication and content presentation processes. For instance, client device 150 may execute software that generates and displays interfaces on client device 150. The disclosed embodiments are not limited to any particular configuration of client device 150.

Client device(s) 150 may be used to perform purchase transactions using technologies known to those of skill in the art including, without limitation, near-field communication (e.g., RFID, ZigBee®, etc.), e-commerce websites, card swiping, payment networks such as ISIS®, QR codes, sound waves such as is employed by Naratte, Inc.®, or any other payment delivery mechanism. In some embodiments, client device(s) 150 are associated with customers of financial service provider 110 and transmit purchase transaction information to financial service provider 110 for authorization of the payment or for reporting. In some aspects, one or more client devices 150—such as client device 150A—may include software applications providing payment services consistent with disclosed embodiments.

Merchant system(s) 160 may be one or more computing systems associated with one or ore merchant entities that provide goods, services, and/or information such as a retailer (e.g., Macy's®, Target®, etc.), grocery store, service provider (e.g., maid service, automobile repair, etc.), or any other type of entity that provides goods, services, and/or information that consumers may purchase, consume, use, etc. Merchant system(s) 160 is not limited to systems associated with merchant(s) that conduct business in any particular industry or field.

Merchant system 160 may be associated with a merchant brick and mortar location(s) that a consumer (e.g., user 152) may physically visit and purchase goods and services. Such physical locations may include merchant system 160, which may include computing devices that perform financial service transactions with consumers (e.g., Point of Sale (POS) terminal(s), kiosks, etc.). Merchant system 160 may also include back- and/or front-end computing components that store data and execute software instructions to perform operations consistent with disclosed embodiments, such as computers that are operated by employees of the merchant (e.g., back office systems, etc.). Merchant system 160 may also be associated with a merchant that provides goods and/or service via known online or e-commerce type of solutions. For example, such a merchant may sell goods via a website using known online or e-commerce systems and solutions to market, sell, and process online transactions. Merchant system 160 may include server(s) that are configured to execute stored software instructions to perform operations associated with a merchant, including one or more processes associated with processing purchase transactions, generating transaction data, generating product data (e.g., SKU data) relating to purchase transactions, etc.

Network 140 may be any type of network configured to provide communications between components of system 100. For example, network 140 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as links between financial service provider system 110, payment processing system 120, payment option provider system 130, client devices 150, and merchant systems 160.

FIG. 2 is a block diagram of another exemplary system 200 for performing one or more operations consistent with the disclosed embodiments. In certain embodiments, financial service provider system 210 may be configured to provide payment services consistent with disclosed embodiments. For example, financial service provider system 210 may include a payment option provider system 230 that is configured to provide payment services in a manner consistent with that disclosed above in connection with payment option provider system 130 shown in FIG. 1. Consistent with disclosed embodiments, payment option provider system 230 may use or otherwise directly communicate with computing devices of financial service provider 210 (e.g., server 211). Furthermore, payment option provider system 230 may directly access memory devices of financial service provider 210 (not shown) to retrieve, for example, financial transaction data associated with customers of financial service provider 210 and one or more merchants associated with merchant system 160. Financial service provider 210 may otherwise be configured and operate similar to financial service provider system 110 disclosed above in connection with FIG. 1. Similarly, payment processing system 220, payment options provider systems 230, client devices 250, and merchant systems 260 may be configured and operate similar o similarly labeled components disclosed above in connection with FIG. 1.

It is to be understood that the configuration and boundaries of the functional building blocks of systems 100 and 200 have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. For example, payment option provider systems 130, 230 may constitute a part of components of systems 100, 200 other than those specifically described (e.g., payment processing system 120, 220, merchant system 160, 260; and/or client devices 150, 250) or may constitute a part of multiple components of system 100 (i.e., a distributed system). Such alternatives fall within the scope and spirit of the disclosed embodiments.

FIG. 3 shows an exemplary system 300 for implementing embodiments consistent with the present disclosure. Variations of exemplary system 300 may be used by financial service provider system 110, payment processing system 120, payment option provider system 130, client devices 150, and/or merchant systems 160. In one embodiment, system 300 may include a server 311 having one or more processors 321, one or more memories 323, and one or more input/output (I/O) devices 322. In some embodiments, server 311 may take the form of a mobile computing device, general purpose computer, a mainframe computer, or any combination of these components. Alternatively, server 311 (or a system including server 311) may be configured as a particular apparatus, embedded system, dedicated circuit, and the like based on the storage, execution, and/or implementation of the software instructions that perform one or more operations consistent with the disclosed embodiments. According to some embodiments, server 311 may comprise web se e (s) or similar computing devices that generate, maintain, and provide web site(s) consistent with disclosed embodiments. Server 311 may be standalone, or it may be part of a subsystem, which may be part of a larger system. For example, server 311 may represent distributed servers that are remotely located and communicate over a network (e.g., network 140) or a dedicated network, such as a LAN. Server 311 may correspond to server 211, or separately to any server or computing device included in financial service provider system 110, payment processing system 120, payment option provider system 130, client devices 150, and/or merchant systems 160.

Processor 321 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 311.

Memory 323 may include one or more storage devices configured to store instructions used by processor 321 to perform functions related to disclosed embodiments. For example, memory 323 may be configured with one or more software instructions, such as program(s) 324 that may perform one or more operations when executed by processor 321. The disclosed embodiments are not limited to separate programs or computers configured to perform dedicated tasks. For example, memory 323 may include a single program 324 that performs the functions of the server 311, or program 324 could comprise multiple programs. Additionally, processor 321 may execute one or more programs located remotely from server 311. For example, financial service provider system 110, payment processing system 120, payment option provider system 130, client devices 150, and/or merchant systems 160, may, via server 311, access one or more remote programs that, when executed, perform functions related to certain disclosed embodiments. Memory 323 may also store data 325 that may reflect any type of information in any format that the system may use to perform operations consistent with the disclosed embodiments.

I/O devices 322 may be one or more devices configured to allow data to be received and/or transmitted by server 311. I/O devices 322 may include one or more digital and/or analog communication devices that allow server 311 to communicate with other machines and devices, such as other components of systems 100 and 200.

Server 311 may also be communicatively connected to one or more database(s) 327. Server 311 may be communicatively connected to database(s) 327 through network 140. Database 327 may include one or more memory devices that store information and are accessed and/or managed through server 311. By way of example, database(s) 327 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, system 300 may include database 327. Alternatively, database 327 may be located remotely from the system 300. Database 327 may include computing components (e.g., database management system, database server, etc.) configured to receive and process requests for data stored in memory devices of database(s) 327 and to provide data from database 327.

FIG. 4 shows a block diagram of an exemplary client device, consistent with disclosed embodiments. Variations of exemplary client device 400 may be used by users 152 and otherwise serve as components of systems 100 and 200. In some embodiments, client device 400 may be client devices 150, 250. In one embodiment, client device 400 may include one or more processors 421, one or more memories 423, and one or more input/output (I/O) devices 422. In some embodiments, client device 400 may take the form of a mobile computing device, such as a smart phone, PDA, tablet, or any combination of these components. Alternatively, client device 400 (or a system including client device 400) may be configured as a particular apparatus, embedded system, dedicated circuit, and the like based on the storage, execution, and/or implementation of the software instructions that perform one or more operations consistent with the disclosed embodiments. According to some embodiments, client device 400 may be a mobile device that executes mobile device applications and/or mobile device communication software that allows client device 150 to communicate with components over network 140.

Processor 421 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in client device 400.

Memory 423 may include one or more storage devices configured to store instructions used by processor 421 to perform functions related to disclosed embodiments. For instance, client device 400 may reflects a mobile device and memory 423 may include a mobile application, such as a mobile banking application, that is configured to perform, when executed by processor(s) 421, one or more operations consistent with disclosed embodiments. For example, memory 423 may include a mobile banking application that performs mobile financial transactions (e.g., mobile payments, etc.) for purchasing one or more goods and/or services from merchant(s) associated with merchant systems 160, 260.

In certain embodiments, memory 423 may be configured with one or more software instructions, such as program(s) 424 and Payment Option App 425 that may perform one or more operations when executed by processor 421. Payment Option App 425 may include instructions for, among other things, performing operations for providing a payment service consistent with disclosed embodiments. The disclosed embodiments are not limited to separate programs or computers configured to perform dedicated tasks. For example, memory 423 may include a single program 424 that performs the functions of the client device 400, or program 424 could comprise multiple programs. Similarly, memory 423 may include a single program Payment Option App 425 that performs functions associated with providing a payment service, or Payment Option App 425 may comprise multiple programs. Memory 423 may also store data 426 that may reflect any type of information in any format that the system may use to perform operations consistent with the disclosed embodiments. In some embodiments, client device 400 may transmit data from memory 425 to one or more components of systems 100, 200, including financial service provider 120, 220. In some embodiments, Payment Option App 425 is included in program(s) 424 and capable of execution by one or more other components of systems 100, 200.

I/O components 422 may be one or more components of client device 400 configured to allow data to be received and/or transmitted by client device 400. I/O devices 422 may include one or more digital and/or analog communication devices that allow client device 400 to communicate with other machines and devices, such as other components of systems 100 and 200, via various wireless technologies known to those of skill in the art.

FIG. 5 shows a flowchart of an exemplary payment option provider system configuration process 500, consistent with disclosed embodiments. At step 510, a payment options provider (via, e.g., server 131, 231) may receive or otherwise collect information regarding a plurality of purchase transitions. For example, server 131, 231 may receive purchase transaction information from merchants (e.g., merchant systems 160, 260) when customers of the merchants (e.g., users 152A, 152B-n) make a purchase using a financial product provided by financial service provider 110, 120. In other embodiments, a payment option provider may partner with one or more financial service providers and/or merchants to obtain the purchase transaction information. In still other embodiments, server 131, 231 may be involved in the purchase transaction and observe the purchase transaction information directly. At step 520, server 131, 231 correlate payment types with merchants based on the purchase transaction information. For example, server 131, 231 may determine that merchant 160, 260 accepts a particular form of payment (i.e., VISA®, Paypal®, near-field communications, web interface, etc.) because it processed a payment from one of its customers (i.e., user 152) to merchant 160, 260 using that particular form of payment. Server 131, 231 may compile such information on a continuing basis.

At step 530, server 131, 231 may make such a correlation for every merchant identified as part of a purchase transaction processed by financial service provider 120, 210 and store the information according to merchant in memory (e.g., databases 327). In some embodiments, server 131, 231 may identify one or more preferred payment methods for users and/or merchants based on the correlations. Additionally or alternatively, server 131, 231 may receive preference information associated with payment types directly from users 152 and/or merchants associated with merchants 160, 260 based on, for example, registration information of the user and/or merchant when registering for the disclosed payment service. In some embodiments, server 131, 231 may maintain account information with user 152, 252 and/or merchants 160, 260 that can be subsequently updated by user 152, 252 and/or merchants 160, 260. Server 131, 231 may thus store information concerning one or more preferences of user 152, 252 and/or merchants 160, 260.

At step 540, server 131, 231 may identify user and/or merchant preferences for one or more payment types, as well as promotions for one or more payment types. For example, entities associated with a payment method (such as, for example, ISIS®) may offer a discount of processing fees in exchange for selecting the payment method. In some embodiments, server 131, 231 may further identify payment type preferences for financial service provider 110, 120. Preferences for payment types may be based on many factors including, for example, ease of use, cost, availability, etc. In some embodiments, server 131, 231 may create an online environment (e.g., a web portal, electronic messaging, etc.) for providing a competitive market for interchange or other benefits (e.g., rewards points, assumption of liability, interest as part of an extension of credit, or other terms) at the point of sale based on what payment types are available at a given merchant. The competitive market could be based on real-time or non-real-time bidding based on data provided by the customer, financial institution, processor or merchant (e.g., size of transaction, product and/or service being purchased, geographic location, risk associated with the customer, or other considerations). For example, server 131, 231, may be configured to automatically generate, provide and run an online bidding portal (e.g., website, etc.) that is accessible by payment processor(s) 120, 220, for submitting bids to be selected as a provider or processor of the transaction involving user 152, 252 and merchant system 160, 260.

At step 550, server 131, 231 may determine one or more suggested payment types and promotions for one or more users 152, 252 based on the identified information (see, e.g., steps 530 and 540). Server 131, 231 may generate a configuration file for use on client devices 150, 250 reflecting the suggested payment types and promotion types (step 560). In other embodiments, server 131, 231 may generate a configuration file reflecting only merchant, payment processor, and/or financial service provider information and preferences common to all client devices and customizes the configuration file to a particular user (or group of users) upon installation/execution of the configuration file on the client device(s). In some embodiments, client devices 150, 250 store the information associated with user 152, 252 preferences. At step 570, server 131, 231 may transmit the configuration file to client devices 150 using known electronic communication mechanisms and/or processes.

FIG. 6 shows a flowchart of an exemplary mobile device configuration process 600, consistent with disclosed embodiments. At step 610, client device 150A may receive a configuration file from, e.g. server 131, 231. Client device 150A may configure Payment Option App 325 based on the configuration file (step 620). Client device 150A may determine the user is making or will soon make a purchase (step 630). For example, client device 150A may determine that user 152A has entered a merchant using GPS technology, a social network “check-in” feature, entrance to a “check out” portion of a merchant website, placed an item in a virtual shopping cart, or any other indicator of user 152A's location and/or intentions. User 152A may further request payment option information directly from, e.g., Payment Options App 325. At step 640, client device 150A may determine whether a user has automated payment preferences. In some embodiments, a user's automated payment preferences may be reflected as setting in the Payment Options App 325 and/or configuration file. If it is determined the user has automated settings (step 640; Yes), client device 150A may perform the purchase transaction according to the user's automated settings without further user input (step 670). If it is determined the user does not have automated settings (step 640; No), client device 150A may present the user with options with respecting to the funding source, payment options, payment amount, etc. (step 650). In some embodiments, client device 150A may create a competitive market for interchange or other benefits (e.g., rewards points, assumption of liability, interest as part of an extension of credit, or other terms) at the point of sale based on what payment options are available. For example, client device 150A may receive bids from a plurality of payment processors offering promotions encouraging their form of payment type(s) (see discussion associated with step 540). Client device 150A may receive a selection of funding source, payment options, payment amount etc. (step 660). Additional discussion of the presentation associated with steps 650-670 are discussed below with respect to FIG. 8. Client device 150A may further perform the purchase transaction according to the user selection (step 680).

FIG. 7 shows a flowchart of an exemplary customized suggestion process 700, consistent with disclosed embodiments. At step 710, client device 150A may determine one or more payment methods accepted by each of a plurality of merchants indicated in, for example, Payment Option App 325 and/or a configuration file received from server 131, 231. Client device 150A may also identify the payment options available to a user of client device 150A. For example, client device 150A may have received information regarding user 152A's payment options via user 152A input, via Payment Option App 325, that the user has one or more financial accounts with financial account provider 110, 210, possession of one or more digital coupons, etc. Client device 150A may further identify its own payment delivery capabilities, such as internet access, near-field communication interfaces, etc. and provide such information to Payment Option App 325.

At step 730, client device 150A may access payment method preferences for user 152A, 252A, merchant(s) 160, 260, and/or financial service provider 110, 120. As explained above, user 152A, 252A, merchant(s) 160, 260, and/or financial service provider 110, 120 may provide such indication directly to server 131, 231 or such preferences may be observed based on historical financial transaction of users 152 observed by server 131, 231. In some embodiments, user 152A, 252A, merchant(s) 160, 260, payment processor 120, 220, and/or financial service provider 110, 120 may indicate preferences in the form of priority levels for one or more payment options. At step 740, client device 150A may determine applicable promotional offers associated with one or more promotional offers. For example, one or more merchants 160 may offer a purchase discount for using its preferred payment method. Additionally or alternatively, a new payment method may offer benefits (e.g., points in a loyalty or rewards program, discounts on other merchandise, products, or services) and/or discounts for using the payment method in order to encourage use of the new product/payment option. In some embodiments, client device 150A may receive periodic updates from server 131, 231 regarding current promotional offers.

At step 750, client device 150A may provide user 152A with the payment options suggestions. In some aspects, client device 150A may provide the payment option suggestions when it is determined that user 152A is or may soon make a purchase. In some embodiment, if the only one purchase option is available at a particular merchant (e.g., credit card swipe, cash, etc.), client device 150A may provide user 152A with an alert. In other embodiments, client device 150A may provide multiple payment options to user 152A indicating a suggested payment option and/or applicable promotional offers.

FIG. 8 shows an exemplary graphical user interface display sequences, consistent with disclosed embodiments. In some embodiment (see, e.g., step 680). Payment Option App 325 (via client device 150A) may generate and present user 152A with an interface for providing payment options for making a purchase. For example, client device 150A may generate and present user 152A with an interface 810 for choosing of potential funding sources: savings account 811, checking account 812, credit account 813, or PayPal 814. In some embodiments, user 152A may select more than one funding source. In one example, user 152A may select credit account 813 as the funding source, and Payment Option App 324 (via client device 150A) may present interface 815 for choosing from payment options: card swipe 816, QR Scan 817 (which may correspond to a coupon, merchant online payment system hyperlink, etc.), or near-field communication (NFC) 818. One or more payment option may include a promotion offer to entice the user's selection. In FIG. 8, choosing NFC 818 may be configured to include a “special offer.” The disclosed embodiments may be configured to allow user 152A the ability to view additional information regarding the “special offer,” such as 10% of the purchase amount, waiver of processing fees, etc. User 152A may also be presented with the ability to enter a purchase amount ($10.00 821) and finalize the purchase (Pay Now 822). In some embodiments, the purchase amount will not be adjustable. For example, one or more computing devices associated with merchant 160 may be in communication with Payment Option App 325 (via client device 150A, 250A) and provide the purchase amount (and/or available payment options for the merchant).

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. A system for collecting and utilizing payment option information to provide customers with payment options, comprising:
one or more memory devices storing instructions; and
one or more processors configured to execute the instructions to:
receive transaction information regarding a plurality of purchase transactions involving a plurality of merchants and customers of a financial service provider;
determine a merchant and payment type for each of the plurality of purchase transactions based on the received transaction information;
associate one or more of the determined payment types with each the determined merchants;
generate at least one configuration file reflecting the one or more of the determined payment types associated with each of the determined merchants; and
provide the at least one configuration file to at least one client device.

2. The system of claim 1, wherein the system is associated with a server of the financial service provider and the received transaction information comprises payment authorization requests from the plurality of merchants for customer purchases.

3. The system of claim 1, wherein the at least one configuration file configures the at least one client device to:
receive a selection of a merchant payment type from among the determined one or more payment types; and
perform a purchase transaction using the selected merchant payment type.

4. The system of claim 1, wherein the at least one configuration e configures the at least one client device to:
access automated payment settings reflected in the configuration file;
dynamically select a merchant payment type from among the identified one or more payment types based on the automated payment settings; and
perform a purchase transaction without prompting a user for input regarding the payment type to be used.

5. The system of claim 1, wherein the at least one configuration file configures the at least one client device to:
determine that a user is located at a first merchant; and
present the determined one or more payment types that the first merchant is configured to process.

6. The system of claim 1, wherein the at least one configuration file configures the at least one client device to:
identify payment preferences of the user based on information reflected in the at least one configuration file;
identify payment preferences of the merchant based on the at least one configuration file;
access one or more promotions encouraging at least one payment type from among the determined one or more payment types; and
present a subset of the determined one or more payment types that a first merchant is configured to process based on at least one of the user payment preferences, merchant payment preferences, or one or more promotions.

7. The system of claim 1, wherein the one or more processors are further configured to:
receive report information associated with performed purchase transaction from the at least one client device.

8. The system of claim 1, wherein the at least one configuration file configures the at least one client device to:
receive one or more user payment preferences;
provide the one or more user payment preferences to the system.

9. The system of claim 1, wherein the at least one configuration file configures the at least one client device to:
determine the user is located at a first merchant;
access one or more promotions encouraging at least one payment type from among the identified one or more payment types; and
present the one or more promotions with the identified one or more payment types that the first merchant is configured to process.

10. The system of claim 1, wherein the at least one configuration file configures the at least one client device to:
determine the user is located at a first merchant;
receive bids from a plurality of payment processors offering promotions encouraging at least one payment type associated with each respective bidding payment processor; and
present the bids with the identified one or more payment types that the first merchant is configured to process.

11. A method for collecting and utilizing payment option information to provide customers with payment options, comprising:
receiving transaction information regarding a plurality of purchase transactions involving a plurality of merchants and customers of a financial service provider;
determining, via one or more processors, a merchant and payment type for each of the plurality of purchase transactions based on the received transaction information;
associating one or more of the determined payment types with each of the determined merchants;
generating, via the one or more processors, at least one configuration the reflecting the one or more of the determined payment types associated with each of the determined merchants; and
providing the at least one configuration file to at Feast one client device.

12. The method of claim 11, wherein the at least one configuration file configures the at least one client device to:
receive a selection of a merchant payment type from among the determined one or more payment types; and
perform a purchase transaction using the selected merchant payment type.

13. The method of claim 11, wherein the at least one configuration file configures the at least one client device to:
access automated payment settings reflected in the configuration file;
dynamically select a merchant payment type from among the identified one or more payment types based on the automated payment settings; and
perform a purchase transaction without prompting a user for input regarding the payment type to be used.

14. The method of claim 11, wherein the at least one configuration file configures the at least one client device to:
determine that a user is located at a first merchant; and
present the determined one or more payment types that the first merchant is configured to process.

15. The method of claim 11, wherein the at least one configuration file configures the at least one client device to:
identify payment preferences of the user based on information reflected in the at least one configuration file;
identify payment preferences of the merchant based on the at least one configuration file;
access one or more promotions encouraging at least one payment type from among the determined one or more payment types; and
present a subset of the determined one or more payment types that a first merchant is configured to process based on at least one of the user payment preferences, merchant payment preferences, or one or more promotions.

16. The method of claim 11, further comprising;
receiving report information associated with performed purchase transaction from the at least one client device.

17. The method of claim 11, wherein the at least one configuration file configures the at least one client device to:
access one or more promotions encouraging at least one payment type from among the identified one or more payment types; and
present the one or more promotions with the identified one or more payment types that a first merchant is configured to process.

18. The method of claim 11, wherein the at least one configuration file configures the at least one client device to:
receive bids from a plurality of payment processors offering promotions encouraging at least one payment type associated with each respective bidding payment processor; and
present the bids with the identified one or more payment types that a first merchant is configured to process.

19. A tangible computer-readable storage medium s storing instructions executable by one or more processors to cause the one or more processors to perform operations comprising:
receiving transaction information regarding a plurality of purchase transactions involving a plurality of merchants and customers of a financial service provider;
determining a merchant and payment type for each of the plurality of purchase transactions based on the received transaction information;
associating one or more of the determined payment types with each of the determined merchants;
generating at least one configuration file reflecting the one or more of the determined payment types associated with each of the determined merchants; and
providing the at least one configuration file to at least one client device.

20. The storage medium of claim 19, wherein the at least one configuration file configures the at least one client device to:
determine the user is located at a first merchant;
access one or more promotions encouraging at least one payment type from among the identified one or more payment types; and
present the one or more promotions with the identified one or more payment types that the first merchant is configured to process.
